(19) United States
(12) Patent Application Publication
(10) Pub. No.: US 2002/0087515 A1
(43) Pub. Date: Jul. 4, 2002

(54) Data acquisition system

(76) Inventors: Christopher Martyn Swannack, Cambridge (GB); Benjamin Kenneth Coppin, Cambridge (GB); Calum Anders McKay Grant, Cambridge (GB); Christopher Toby Charlton, Cambridge (GB)

Correspondence Address: FINNEGAN, HENDERSON, FARABOW, GARRETT &, DUNNER LLP, 1300 I STREET, NW, WASHINGTON, DC, 20005, US

(21) Appl. No.: 09/800,888

(22) Filed: Mar. 8, 2001

(30) Foreign Application Priority Data
Nov. 3, 2000 (GB) 0026936.5

(51) Int. Cl. G06F 7/00

(52) U.S. Cl. 707/2; 707/3

(57) ABSTRACT

A system (20) is provided which allows for definition of agents for discrimination and classification of data submitted thereto. Each agent is a collection of data defining a topic, or theme, of interest, in natural language. This definition is combined with classification rules which generate classification scores when applied to a document.

Documents are found for submission to the agents by one of two means. Firstly, a searching subsystem (30) acts in accordance with a schedule to submit search requests to search engines in accordance with terms defined by the theme definitions. Secondly, a monitoring subsystem (32) checks newsgroups in accordance with a schedule and retrieves messages for submission to all of the agents in turn.

The present invention is concerned with a system for acquiring data from published sources of information, and for processing the data in accordance with user requirements.

The development of the Internet has led to improvements in the ability to transfer information electronically from one computer to another. One consequence of this is that information is increasingly made available on computer databases for electronic retrieval. This means that more information is now disseminated to a wider audience, about a more extensive range of subjects.

In particular, information about commercial activities, much of it unofficial and possibly commercially damaging, can be disseminated to consumers with ease. Commercial operations are sensitive to the publication of this type of information, because it can have deleterious effect on the reputation of the business. For example, false information about the efficacy of pharmaceuticals or safety of foodstuffs can be circulated to a wide audience, before a commercial entity becomes aware of the information. By the time the commercial entity has managed to take steps to prevent the further circulation of information, that information may already have had a commercially damaging effect.

Items of information concerning a particular subject for retrieval via the Internet can be sought and identified by means of search engines. Most search engines are operable to receive an input consisting of a string of text. This string of text is known as a search string, which is used by the search engine to find matches, or near matches, in the content of items of information accessible to the search engine. Such items of information can include websites and newsgroups. The search engine then presents a list of results to the user. The list identifies websites and newsgroups considered by the search engine to have a match with the search string. The match can be an exact match, or provision can be made for the search engine to identify near matches to the search string, near matches being determined by truncations, letter transpositions or letter replacements within the search string.

A disadvantage of the search engine of this type is that it can deliver erroneous results. For example, if the search string is too short, or relates to too general a subject, then a match to the string may be found in a large number of websites. The content of many of those websites may be wholly unrelated to the subject matter of the search string, the inclusion of the search string in the website being entirely coincidental. Thus, if an investigator making use of a search engine on behalf of a commercial entity searches on the basis of a well known trade mark, many instances of use of that trade mark may arise which are of no interest to the investigator. Review of all of these websites can be labourious and extremely time consuming.

Also, many search engines make use of “meta tags” which are strings of text embedded in web page descriptions by a web page designer but which do not cause display output. Meta tags are used by web designers to maximise the chance that a website will be identified by a search engine as relating to a particular subject. However, it may be commercially advantageous to a web designer to include a large number of meta tags relating to diverse subjects, causing a search engine to erroneously identify a website as relating to a search string not entirely related to the subject matter of the website, so that the website is regularly found by search engines and thus receives more commercial exposure. An investigator can find this disadvantageous because many websites may be identified with a search engine, which include meta tags which relate to the search string, but which are in fact not relevant to the subject matter defined by the search string.

On the other hand, if the investigator chooses a search string which is too long or too specific, investigation may not be sufficiently thorough, because many websites may be overlooked by the search engine which, in fact, relate wholly to the subject matter of the search string but which do not contain text which exactly or nearly exactly matches the search string.

Furthermore, some search engines provide collated information to a user. This information consists of identified websites and newsgroups, categorised by subject matter. These categories are presented to the user in a hierarchical tree structure; the category headings can be searched with respect to a search string in the same way as described above in relation to a search of website contents. However, a disadvantage of this arrangement is that it relies on the investigator understanding the manner in which websites have been categorised into particular categories in the hierarchical structure, and for the investigator to check the correct categories for the subject under investigation. It is possible that the investigator might overlook categories which are of relevance, or that the person who categorised the websites into the categories might have wrongly categorised a website into a category which the investigator does not consider sufficiently relevant as to warrant investigation. This can mean that an investigator can overlook websites which are of relevance to the subject under investigation. Also a website investigator might find checking a large number of categories, to ensure the thoroughness of the search, laborious and time consuming.

In addition to performing searches using search engines, an investigator working on behalf of a commercial organisation to establish whether that organisation is being discussed in a potential commercially damaging manner, can make investigations of messages being posted in newsgroups. Newsgroups are facilities operable using network news transfer protocol (NNTP) which allow messages to be posted in a central server for retrieval and review by users. The contents of newsgroups can be highly dynamic, with the contents of a newsgroup typically being replaced every three days. Thus, for an investigator to monitor the contents of newsgroups can be time consuming and laborious. A large number of newsgroups and a large number of messages on each newsgroup must be reviewed in order to establish whether any damaging messages are being posted. Also, if an investigator finds it necessary to check a large number of newsgroups, it may not be possible to review all messages in the time available before messages are deleted from the newsgroup and new messages are posted.

Whereas search engines are configured to search and identify newsgroups as relating to a subject signified by a search string, they generally only search newsgroup headings, and newsgroup descriptions if available. Messages posted on newsgroups may contain relevant information, but will not be detected since the search engine will not search through messages.

Therefore, it is an object of the invention to provide a system capable of collecting data and processing the data to present relevant data therein to a user.

It is a further object of the invention to provide a system capable of configuring search engines to retrieve and classify data in accordance with a user requirement.

It is another object of the invention to provide a system operable to monitor published data sources for relevant information and to deliver relevant information as required.

These and other objects may be achieved, wholly or in part, by the invention, aspects of which are set out below.

One aspect of the invention provides means for storing instructions for transmittal to a search engine for generation of search results, means for receiving search results retrieved by a search engine in response to one of said instructions, and means for processing said search results to establish which of said results are sufficiently relevant, relative to a user determined relevance criterion, to be output to a user.

Another aspect of the invention provides means for storing instructions for transmittal to search engines, means for retrieving search results from search engines in response to said instructions, means for retrieving, in accordance with said search results, items of information corresponding to said search results, and means for processing said items of information to identify relevance or otherwise thereof.

Another aspect of the invention provides apparatus for retrieving and processing information comprising means for storing instructions for retrieval of information, means for storing retrieved units of information and means for identifying relevance of said information in accordance with predetermined criteria.

In accordance with another aspect of the invention, apparatus is provided which comprises means for receiving a user input instruction indicating a document relevance criterion, means for reviewing the content of an item of information with respect to said received instruction, and means f or storing a value representative of the relevance of said item of information with respect to said document relevance criterion.

Another aspect of the invention provides apparatus for retrieving and processing information held in units in a remote location, comprising means for retrieving information in accordance with a predetermined sequence, and discrimination means operable to test a unit of retrieved information against one or more predetermined criteria and to generate a score for said unit of information on the basis of said one or more criteria.

Further aspects and advantages of the invention may become apparent from the following description of a specific embodiment of the invention, with reference to the accompanying drawings in which:

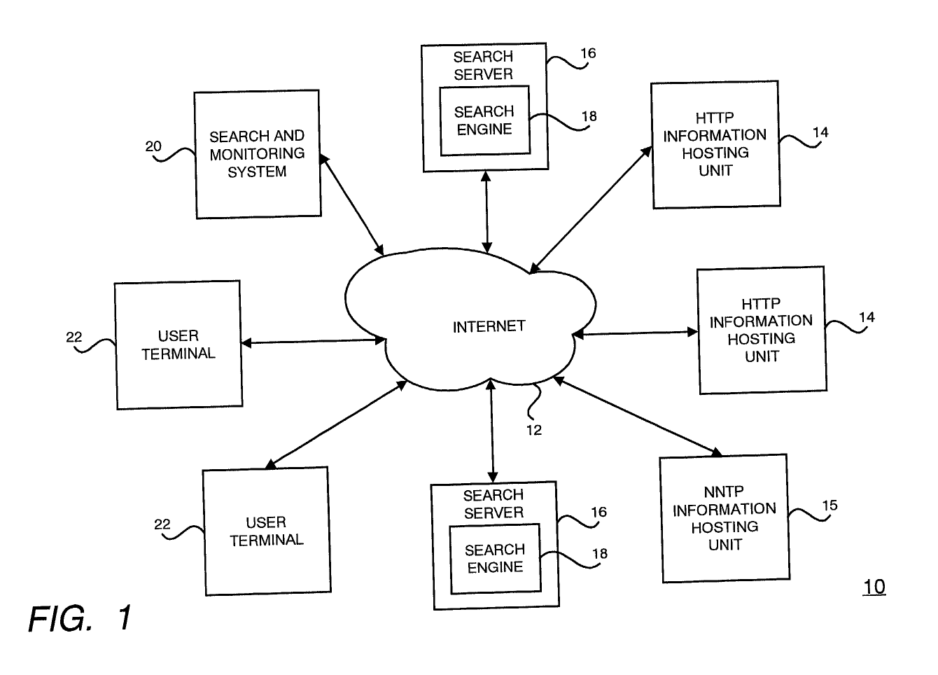

FIG. 1 is a schematic diagram of a network of computers connected via the Internet, including a search and monitoring system in accordance with a specific embodiment of the invention;

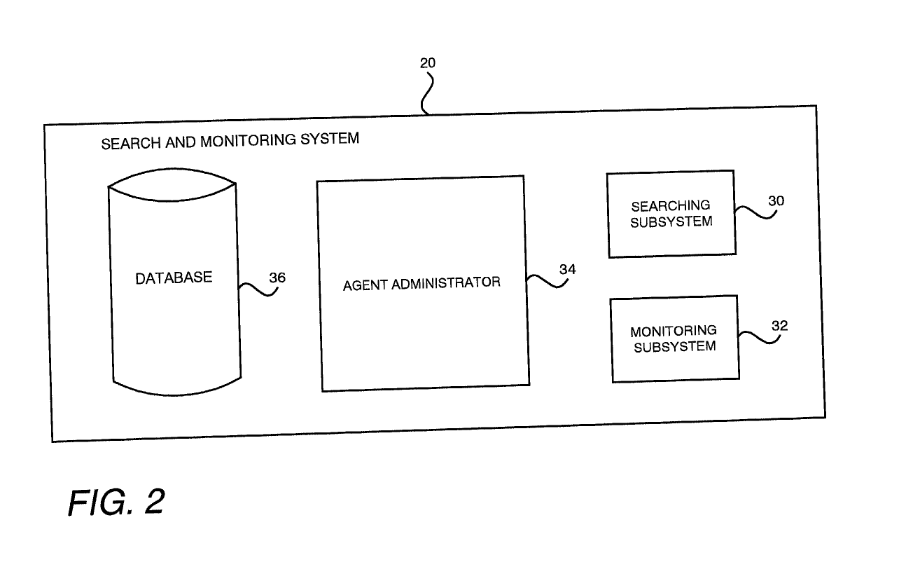

FIG. 2 is a schematic diagram of the search and monitoring system illustrated in FIG. 1;

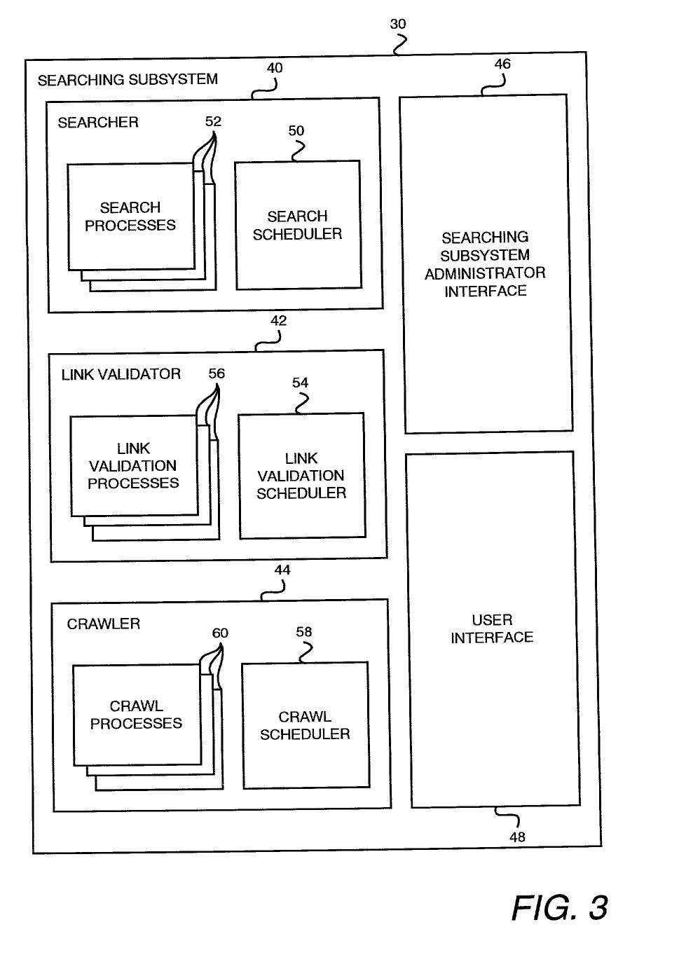

FIG. 3 is a schematic diagram of a searching subsystem of the search and monitoring system illustrated in FIG. 2;

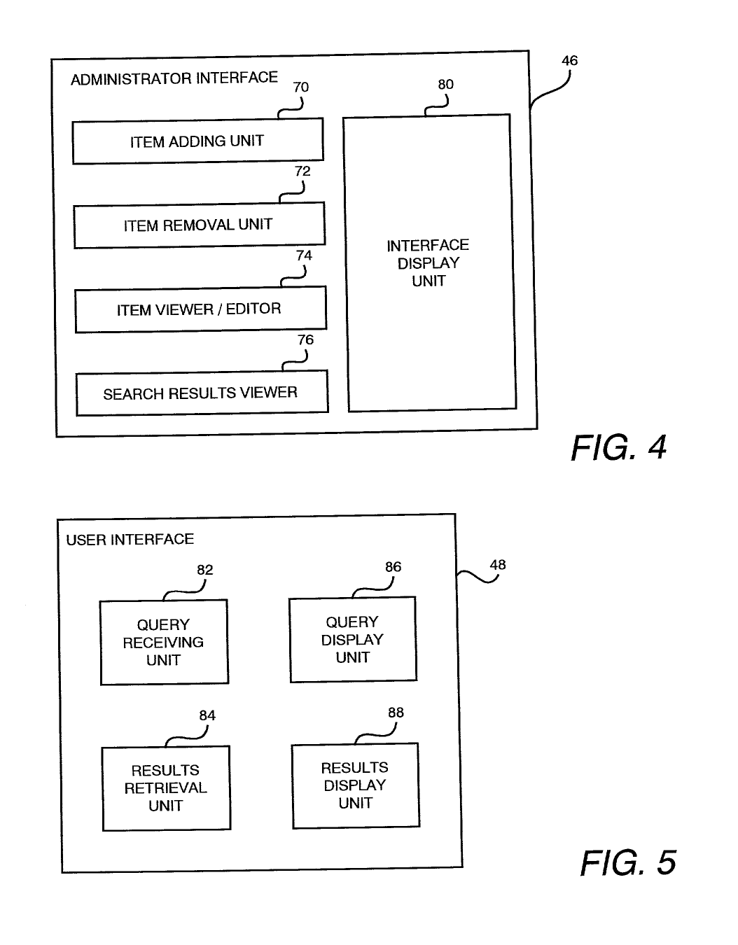

FIG. 4 is a schematic diagram of an administrator interface of the searching subsystem illustrated in FIG. 3;

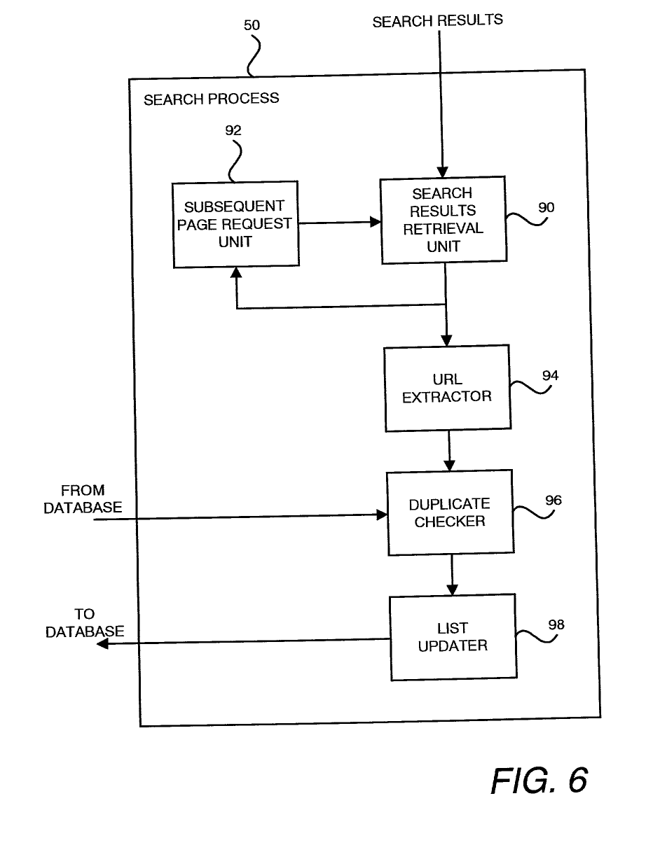

FIG. 5 is a schematic diagram of a user interface of the searching subsystem illustrated in FIG. 3;

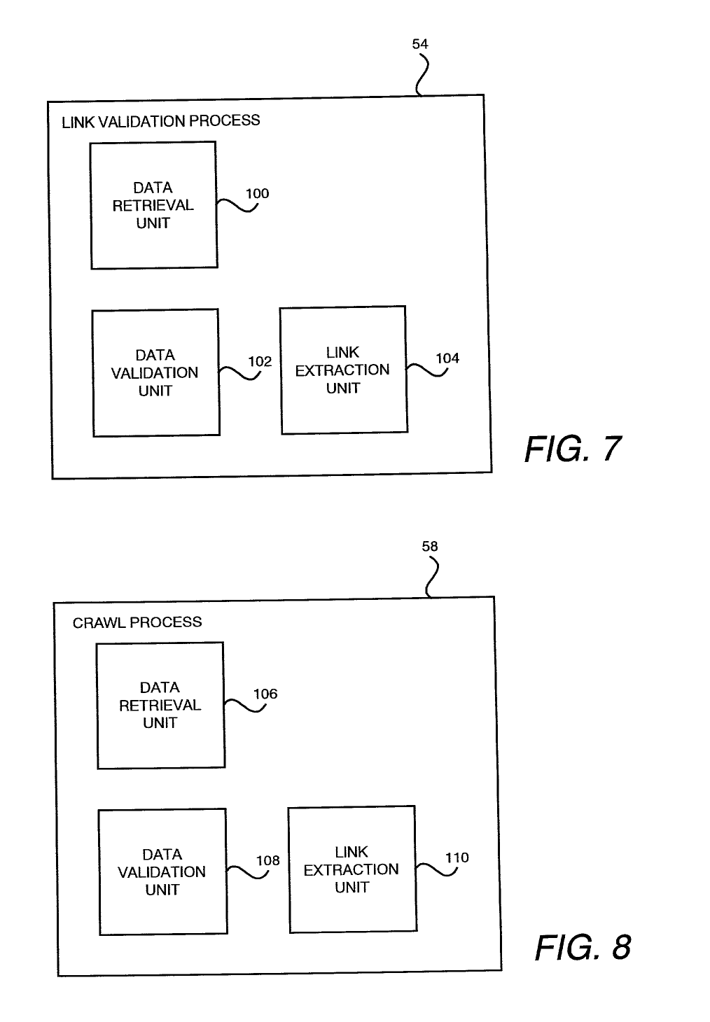

FIG. 6 is a schematic diagram of a search process of the searching subsystem illustrated in FIG. 3;

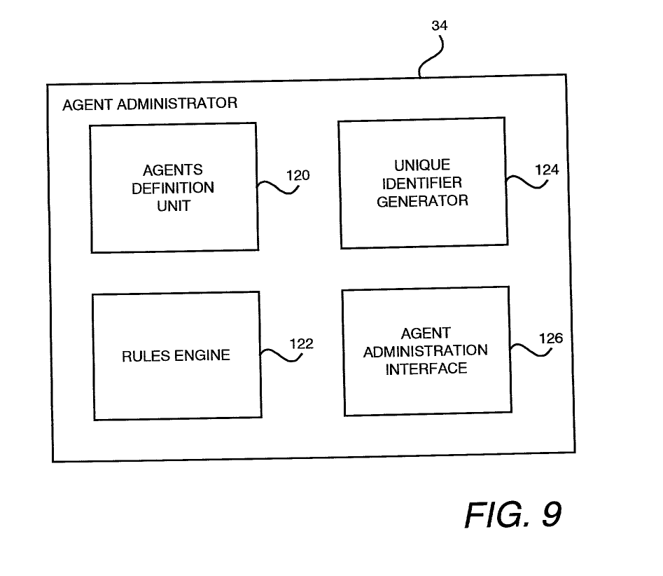

FIG. 7 is a schematic diagram of a link validation process of the searching subsystem illustrated in FIG. 3;

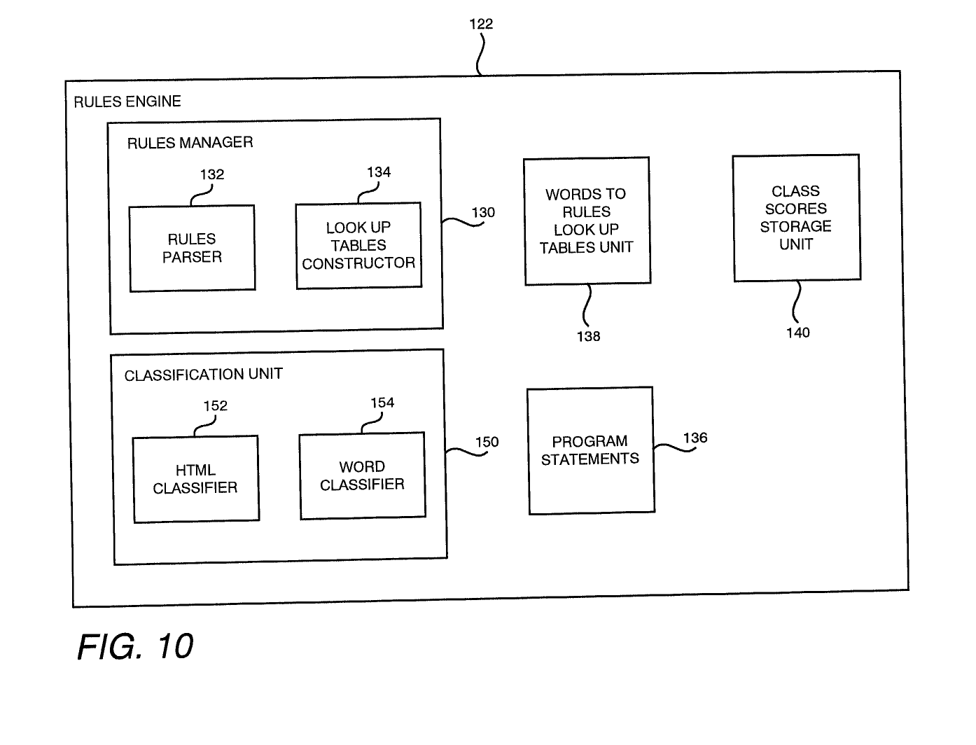

FIG. 8 is a schematic diagram of a crawl process of the searching subsystem illustrated in FIG. 3;

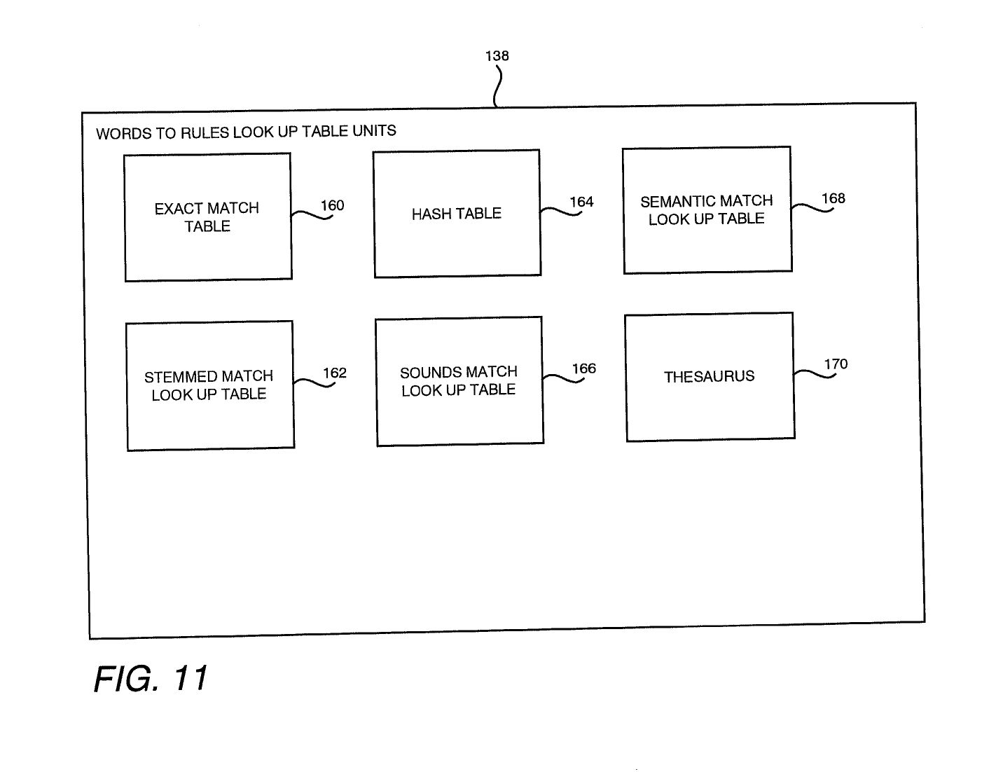

FIG. 9 is a schematic diagram of an agent administrator of the search and monitoring system illustrated in FIG. 2;

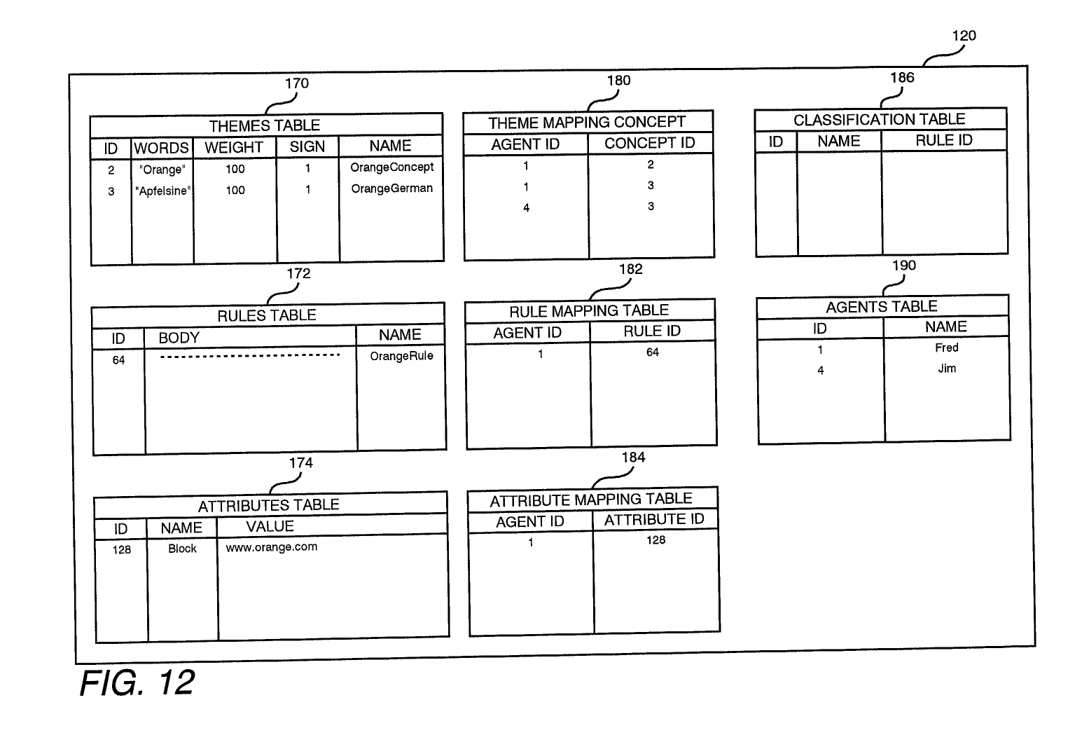

FIG. 10 is a schematic diagram of a rules engine of the agent administrator illustrated in FIG. 9;

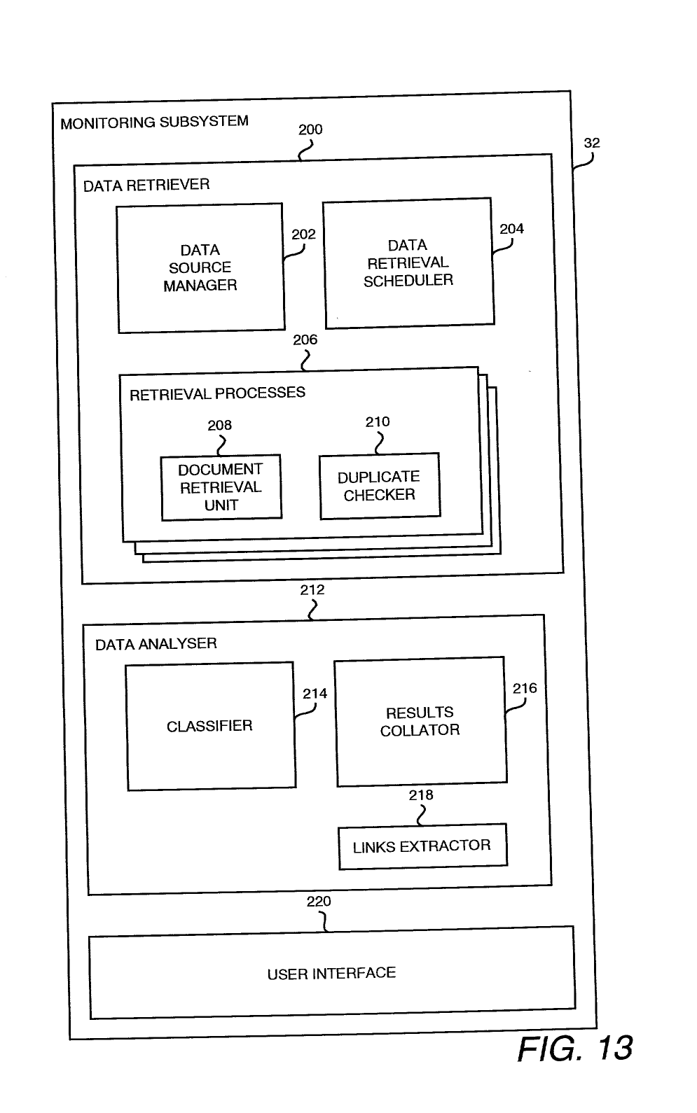

FIG. 11 is a schematic diagram of words to rules look up tables of the rules engine illustrated in FIG. 10;

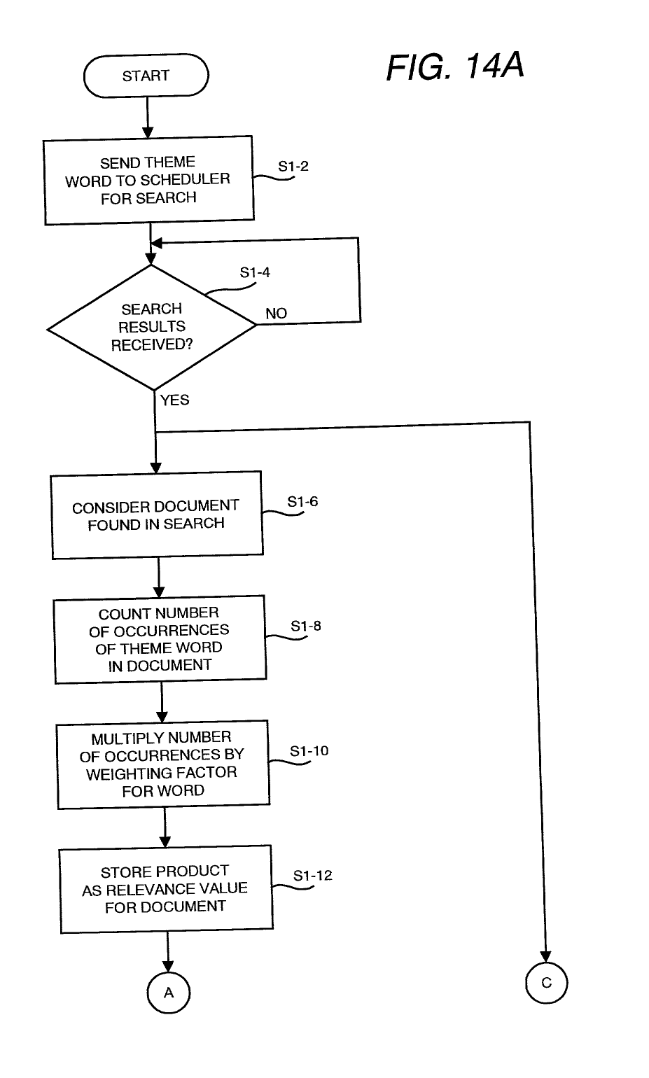

FIG. 12 is a schematic diagram of an agents definition unit of the agent administrator illustrated in FIG. 9;

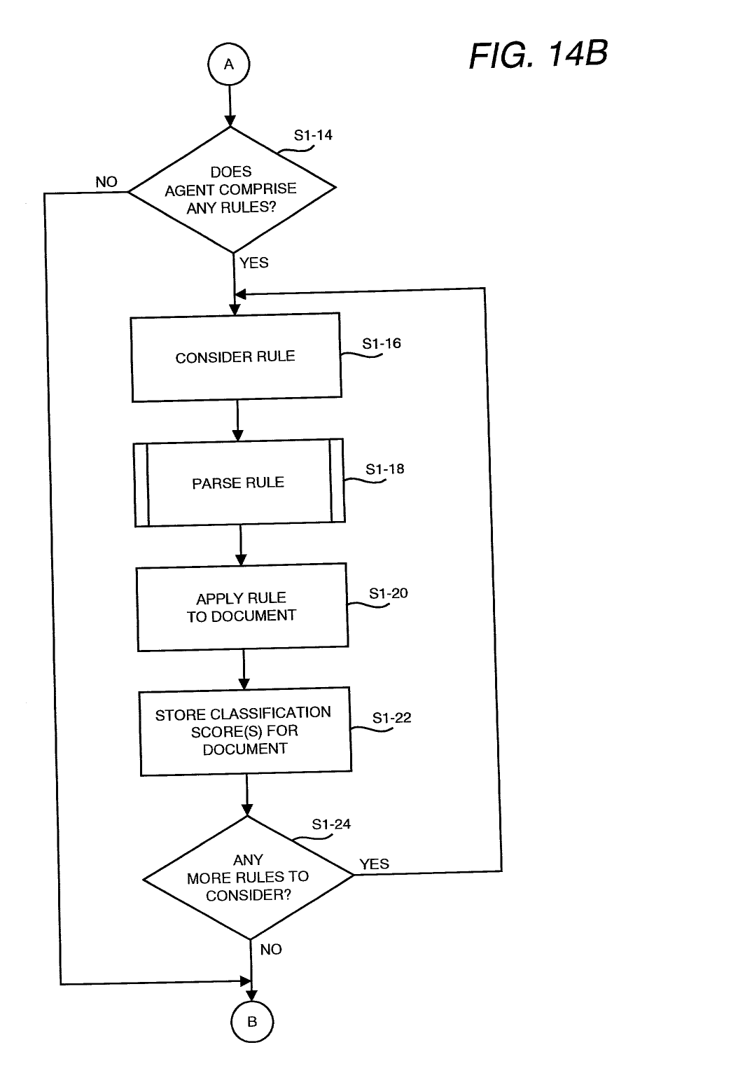

FIG. 13 is a schematic diagram of a monitoring subsystem of the search and monitoring system illustrated in FIG. 2;

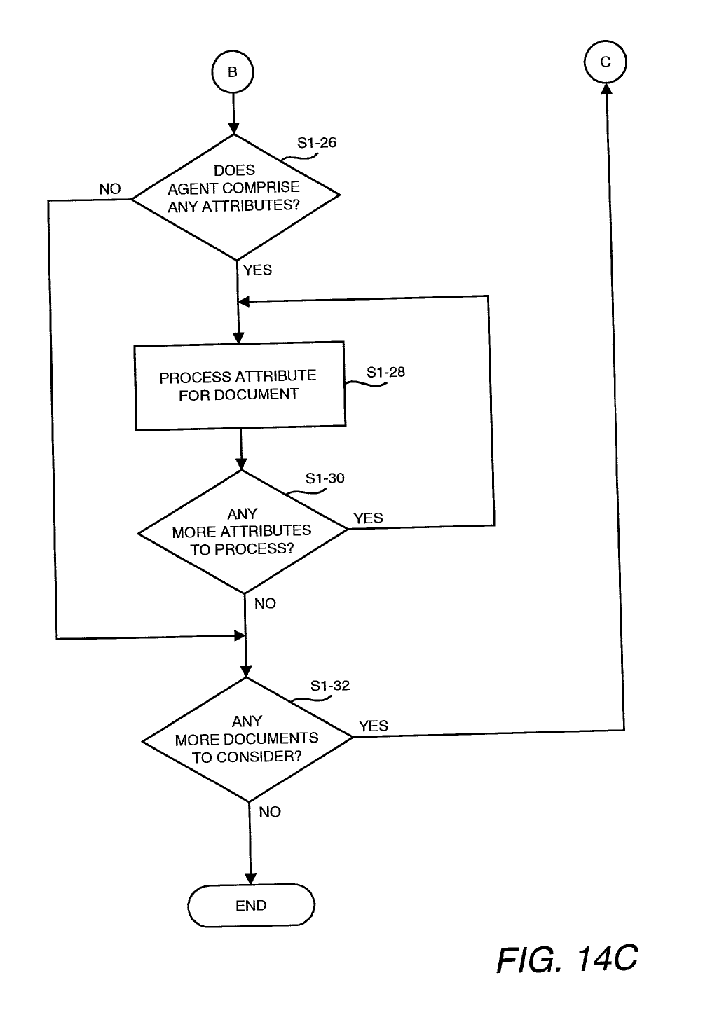

FIG. 14 is a flow diagram demonstrating operation of agent administrator illustrated in FIG. 9;

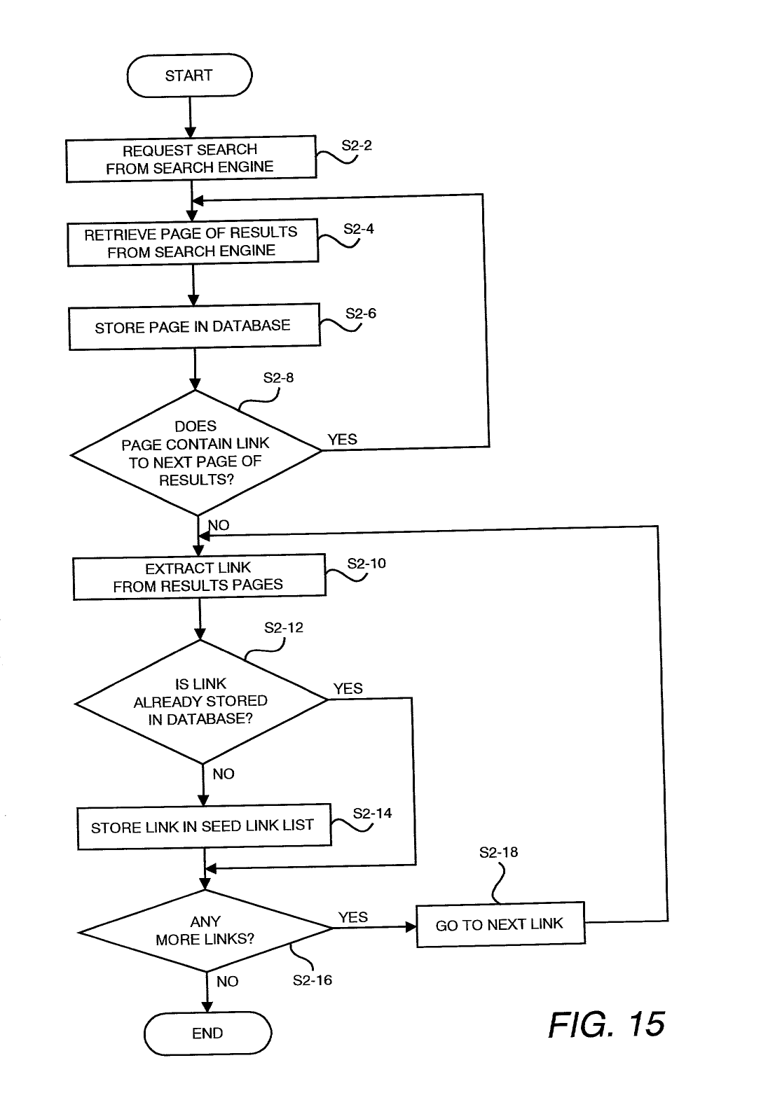

FIG. 15 is a flow diagram demonstrating operation of a search process as illustrated in FIG. 5;

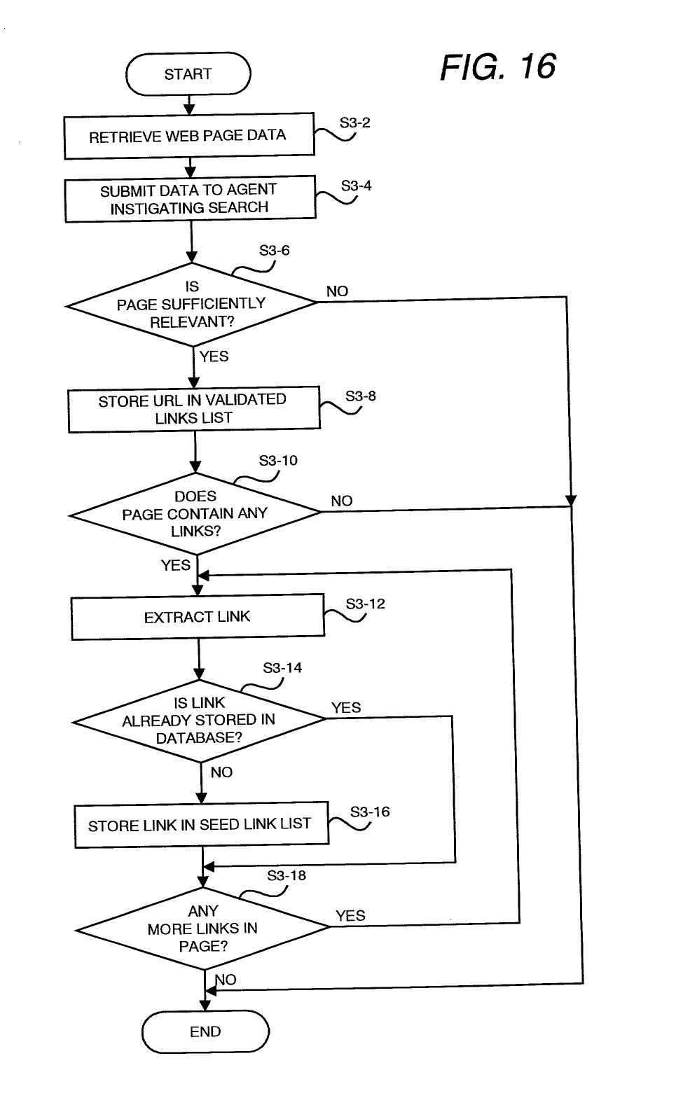

FIG. 16 is a flow diagram demonstrating operation of a link validation process as illustrated in FIG. 3; and

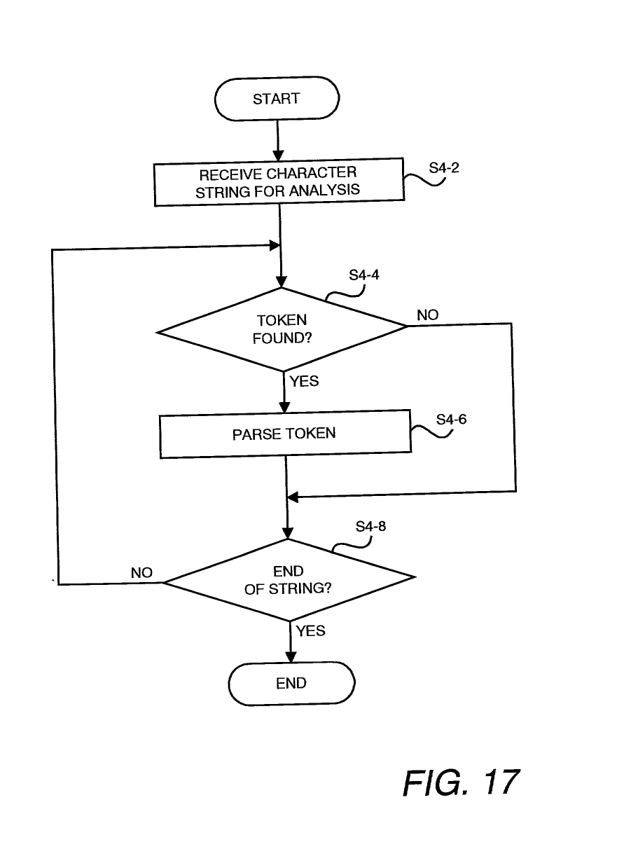

FIG. 17 is a flow diagram illustrating operation of a rules parser of the rules engine illustrated in FIG. 10.

FIG. 1 illustrates a computer network in which a plurality of computers are arranged f or communication with each other via the Internet 12. A search and monitoring system 20 in accordance with a specific embodiment of the invention is communicable via the Internet 12 with information hosting units 14, 15, including hypertext transfer protocol (HTTP) information hosting units 14 and a network news transfer protocol (NNTP) information hosting unit 15, of which only one or two are illustrated in FIG. 1; it will be appreciated that a very large plurality thereof will be communicable with the search and monitoring system 20 via the Internet 12.

Two search servers 16 are connected with the Internet 12, each search server 16 hosting a search engine 18 which is operable to retrieve information contained in web pages and in usenet newsgroups and to deliver information to a user in response to search requests. User terminals 22 are illustrated in FIG. 1, communicable with the search and monitoring system 20 by means of the Internet 12. Each user terminal 22 has access to the search and monitoring system 20 to cause the search and monitoring system 20 to configure the search engines 18 to make searches of the information hosting units 14, 15 and to carry out monitoring operations of the information held on the information hosting units 14, 15.

The search and monitoring system 20 stores definitions of themes on the basis of which searches are to be carried out. A theme is constructed from a description of subject matter, such as might be manually input by a user or might be retrieved from an encyclopaedia. The frequency of words contained in the theme definition in the language of the theme description is noted for use in classifying a document as to its relevance to the theme.

Searches are categorised by the search and monitoring system in relation to the themes, which are linked with classification rules. Also, the search and monitoring system 20 can follow links embedded in web pages identified in search results from the search engines 18, those links being to further web pages which are retrieved and categorised in the same way. Then, the search and monitoring system 20 is capable of outputting lists of web pages suitably categorised in relation to the categorisation instructions submitted by the user at the user terminal 22.

Also, the user terminal 22 can be used by a user to send instructions to the search and monitoring system 20 to carry out monitoring of information at a website hosted on an HTTP information hosting unit 14 or a newsgroup at an NNTP information hosting unit 15. The monitoring operation carried out by the search and monitoring system 20 consists of periodically retrieving information from the identified information source, and considering the content of the retrieved information relative to classification rules. On classification of the retrieved information, a list of any identified items of information which are deemed sufficiently relevant is then returned to the user terminal 22.

The search and monitoring system 20 will now be described in further detail with reference to FIG. 2. The search and monitoring system 20 includes a searching subsystem 30 which manages the searching operation as configured by instructions from the user terminal 22, and a monitoring subsystem 32 which manages monitoring operations configured by further instructions from the user terminal 22. The searching subsystem 30 is operable to send instructions to the search engines 18. These instructions consist of search strings to be applied to the information retrievable by the search engine 18. The search strings sent to search engines are extracted from the theme definitions on the basis of which searches are to be performed. Searches are only carried out on the basis of descriptive words, so words such as “the” and “and” would be excluded from the theme definitions, by virtue of their frequency in the English language. Information submitted by the search engine 18 to the searching subsystem 30 will comprise pages of hypertext containing links to relevant web pages and newsgroups.

These pages of results are then analysed by the searching subsystem 30, the searching subsystem 30 retrieving the web pages and newsgroups identified by those links. Each item of information, whether a web page or a message held in a newsgroup, is then submitted to an agent administrator 34 which contains definitions for discrimination agents. Each discrimination agent comprises one or more search strings, defining themes for searches. These are the basic instructions for configuring a search engine 18 to retrieve data. In addition to the theme or themes, an agent can include various discrimination rules which, when applied to items of information retrieved on the basis of a theme, can be used to perform a classification score for the item of information to establish its relevance. The themes and rules are configured by a user at the user terminal 22.

Also, a number of predefined agents are provided, allowing a user to select one of those agents for use rather than to undertake complex decisions and to use of a rules language to construct his own agents. The data defining the agents is held in a database 36, accessible via the agent administrator 34.

The same agents administered by the agent administrator 34 are used by the monitoring subsystem 32. A schedule of monitoring operations is defined by the monitoring subsystem 32 on the basis of instructions from a user terminal 22, and that schedule is held in the database 36. In accordance with the schedule, monitoring operations are carried out by the monitoring subsystem 32, which retrieves messages, via network news transfer protocol (NNTP), from NNTP information hosting units 15. Each message retrieved by the monitoring subsystem 32 is submitted to the agent administrator 34 to establish if any of the agents defined in the database 36 comprises themes, rules or classification instructions to which the content of the item of information is of any relevance. A list of relevant items of information is assembled in the database 36 for submission to the user terminal 22.

The searching subsystem 30 and the monitoring subsystem 32 can operate in parallel, each submitting items of information for consideration by the agent administrator 34.

The searching subsystem 30 will now be described with reference to FIG. 3. A searching subsystem 30 comprises a searcher 40 which manages search requests to be sent to search engines 18 and is operable to receive search results from a search engine 18. Search results from search engines habitually consist of one or more pages of text in HTML (hypertext mark up language), each page comprising a list of hypertext links to identified relevant web pages and usenet newsgroups.

The searcher 40 comprises a search scheduler 50 which administers a schedule of searches to be carried out by search engines 18. The schedule is arranged, on the basis of administrator input action, to initialise searches at search engines to cause those search engines to submit search results regularly without overly burdening the search engines with too many requests. To initiate a search, the scheduler 50 instances a search process 52, to be executed on the search subsystem 30. Each search process 52 retrieves pages of search results according to its configuration and builds a list of links to websites referred to in the results.

A link validator 42 takes the list of links collated by the search processes 52 executed by the searcher 40 and checks the contents of the linked pages or documents for their relevance. The link validator 42 has a link validation scheduler 54 for that purpose. The scheduler 54 establishes a schedule, in accordance with administrator preferences, for the retrieval of items of information so that they can be validated. As for the search scheduler 50, notice must be taken of external factors such as bandwidth, and Internet access charges.

It may be convenient to configure the link validation scheduler 54 to cause retrieval of data when data transfer speeds are high (during periods of low usage), or access charges are low, such as overnight. The link validation scheduler 54 is operable to instance, for each link identified by the searcher 40, a link validation process 56. Execution of the link validation process 56 causes retrieval of an item of information identified by the link in question, submission to the agent which defined the search resulting in the link under consideration and extraction of any links to further items of information held in the item retrieved from the link under consideration. The retrieved item is then rejected or accepted by the agent as determined by the criteria set thereby, and, if the item is accepted, extracted links are added to the list of links to be validated.

A crawler 44 is provided which follows links, looking for further relevant units of information. The crawler 44 includes a crawl scheduler 58 which is configured by administrator preferences to instance crawl processes 60 to be executed. A crawl process 60 follows links in a crawl link list held in the database 36, to build up a list of web pages relevant to particular themes defined in the agents. Crawl processes 60 are scheduled to be carried out at times which will allow higher priority processes, instanced by the search scheduler 50 and the link validation scheduler 54, to be carried out without interruption.

All of these units are configured by a searching subsystem administrator interface 46 and a user interface 48. The searching subsystem administrator interface 46 is accessible locally, by password only, to ensure that only authorised users can have access to the configuration commands available through the searching subsystem administrator interface 46. The user interface 48 is accessible by user terminals, such as user terminals 22 illustrated in FIG. 1, and is operable to supply to a user terminal an HTML defining a form which offers functionality to enable a user to configure the searching subsystem to perform a search on his or her behalf.

The administrator interface 46 comprises a plurality of functional elements designed to allow an administrator to enter information and to amend that information for configuration of the searching subsystem 30. Each element is illustrated in schematic form in FIG. 4.

An item adding unit 70 is provided which offers, to an administrator, a facility for the creation of an item of information which will be converted into an agent within the agent administrator 34. An agent is operable to review and discriminate the results of searches carried out by the searching subsystem 30, and can comprise definitions of themes, rules and other attributes appropriate to define subject matter used as discrimination criteria by the agent.

An item removal unit 72 is provided which allows a user to remove information defining an agent from the agent administrator 34. An item viewer/editor 74 allows for existing items of information to be amended, and a search results viewer 76 receives search results from other parts of the searching subsystem, for presentation to a user. An interface display unit 80 is provided which governs display of information in a graphical user interface to an administrator, providing areas on screen which can be used for the entry of information at a keyboard of the device, for transfer to one of the item adding unit 70, the item removal unit 72 and the item viewer/editor 74.

The user interface 48 illustrated schematically in FIG. 5 is operated at the search and monitoring system 20. The user interface 48 causes a graphical user input display to be downloaded to a user terminal 22 on request, for the entry of request information at that terminal, and for display of search results also. The user interface comprises a query receiving unit 82, which is operable to receive query information from a user at the user terminal 22. A results retrieval unit 84 retrieves results from the database 36, on the basis of operation of the searcher 40, the link validator 42 and the crawler 44. A query display unit 86 is operable to display the aforementioned graphical user display and the results display interface 88 causes the results retrieved by the results retrieval unit 84 to be sent to the appropriate user terminal 22 for display.

In operation, the search scheduler 50 refers to agents administered by the agent administrator 34 and stored in the database 36, to establish which searches are to be carried out. The search scheduler 50 is operable to construct a list of searches to be carried out, each to be carried out at a particular time. The search scheduler 50 is operable not to overburden a search engine 18 by making unreasonable demands on it; instead, it schedules searches to be issued no more frequently than five seconds apart. The search scheduler 50 instances a search process 52 for each search to be carried out. Each search process 52 is constructed as illustrated in FIG. 6, and its operation is illustrated by the flow diagram illustrated in FIG. 13.

Each search process 52 has a search results retrieval unit 90 which, in step S2-4 in FIG. 15, retrieves results from a search engine 18 instructed by the search process 52 in step S2-2. The search results retrieval unit 90 is operable to retrieve a page of results, defined in hypertext mark up language (HTML) which it stores in the database 36 in step S2-6 and passes to a subsequent page request unit 92. In step S2-8, the subsequent page request unit 92 checks whether the page received by the search results retrieval unit 90 contains a hypertext link to a subsequent page of results. If so, then this subsequent page of results is requested by the search results retrieval unit 90 in step S2-4 et seq.

This process continues until no further pages of results are to be retrieved. The pages of results are passed to a URL extractor unit 94.

The URL extractor unit 94 analyses the HTML data retrieved by the search results retrieval unit 90, and in step S2-10 extracts URLs (Unique Resource Locator) from those pages. These URLs refer to pages identified by the search engine as being relevant to the instructed search. Each URL is checked in step S2-12 by a duplicate checker 96 against a list of URLs stored in the database 36. If the URL in question is not contained in the database already, then it is placed in the database in step S2-14 by a list updater 98. The routine then checks in step S2-16 to establish if any more links exist in the results pages to be extracted. If so, then in step S2-18 the next link is considered. Otherwise, the routine ends, and the search process 52 has been completed.

In that way, a list of URLs, without duplicates, is constructed from the search results. This list is known as a list of seed links, since these links form the basis for further searching and assessment of results by other parts of the searching and monitoring system 20. The seed links are referred to by the link validator 42 which has a link validation scheduler 54 with substantially the same function as the search scheduler 50. However, in this case, the link validation scheduler 54 instances a link validation process 56 for each link in the seed link list. The scheduling of link validation processes is carried out on the basis of the time necessary for retrieval of data from the URL concerned, which can be adjusted to the capabilities of the particular system on which the searching subsystem 30 is implemented, and of its connection to other computers via the Internet 12.

The structure of a link validation process 56 is illustrated in FIG. 7, and its operation in FIG. 16. Each link validation process 56 comprises a data retrieval unit 100 which is operable in step S3-2 to retrieve data from the location indicated by the URL. The data retrieved by the data retrieval unit 100 is analysed by a data validation unit 102 in step S3-4.

In step S3-6, the data validation unit 102 makes reference to the agent which instigated the search from which the URL results, to establish if the data retrieved is of relevance to the theme defined by the agent. If the data is not sufficiently relevant, the data is discarded. If the data is sufficiently relevant, then in step S3-8 the URL is further stored in the database as a validated link, and a check is made in step S3-10 as to whether the page under consideration contains links to further pages. If so, in step S3-12 one of these further links is extracted by a link extraction unit 104 from the validated data.

The link is tested in step S3-14 to establish if it is already stored in the database, as a seed link. If not, in step S3-16, the link is added to the list of seed links, ready to be validated by further link validation processes 56. In step S3-18, a check is then made as to whether any more links are contained on the page, and if so, the procedure returns to step S3-12. This loop continues until all of the links in the page have been considered.

Link validation processes 56 continue to be instanced by the link validation scheduler 54 until such a time that the number of links which have been extracted exceeds a predetermined threshold, or all relevant links have been validated and no further links remain to be considered.

Subsequently, the crawler 44, which has a crawl scheduler 58 of similar structure to the link validation scheduler 54, instances crawl processes 60 for the validated URLs. The structure of a crawl process 60 is illustrated in FIG. 8 and the procedure performed thereby is the same as that illustrated in FIG. 16. Each crawl process 60 comprises a data retrieval unit 106, which retrieves the data located at a particular URL from its location. Then, the data is further analysed in a further data validation unit 108, with reference to the agent administrated by the agent administrator 34 which instigated the search from which the URL resulted, and links are extracted in a link extraction unit 110 for further retrieval and analysis.

The agent administrator 34 is illustrated in further detail in FIG. 9. The agent administrator provides a mechanism by which the searching subsystem 30 and the monitoring subsystem 32 can request services from agents, and also so that an administrator or a user can create, delete and manage agents. An agent is a collection of definitions of themes, rules and categories which can be used to manipulate textual data and to search for it in various ways.

In particular, an agent can comprise a collection of designations of themes, rules and attributes which, together or separately, can be used to classify a piece of textual data. The result of classification is one or more classification scores. In the agent administrator 34, an agents definition unit 120 defines agents in terms of their rules, attributes and themes. A rules engine 122 is used to manage rules, to test data against those rules, and to generate output based on those tests.

When a piece of data is submitted to an agent, a preliminary check is carried out by the agent with respect to one or more themes defined thereby. Each theme is a collection of words, each assigned weightings corresponding to expected frequency in a piece of text. A word having a low frequency in an average piece of text is assigned a high weighting, and a word having a high frequency in an average document is assigned a low weighting. In certain cases, such as for example in the case of the word “the”, words are assigned zero weighting.

The actual incidence of words in the submitted data is tested against the words contained in the themes and a collective score is obtained for the theme in relation to the submitted data. This weighting gives a general impression as to the relevance of the data to a particular theme. In order to compensate for the possible grammatical inflection of words in a piece of data, a stemming function is applied to the words in the theme. Following this informal relevance check, the rules contained in the agent are applied to the data, for a more thorough classification of the data.

A unique identifier generator 124 is used to ensure that rules, attributes, themes and agents are given unique identification numbers which can be used to ensure no ambiguity in referring to those items. An agent administration interface 126 provides an interface between the agents defined in the agents definition unit 120 and the other units in the system, and also to allow an administrator user to define agents as required.

The rules engine 122 is responsible for analysing the contents of a text document, and for compiling scores for the document. It does so by applying rules, stored in the database and referred to by the agents definition unit 120, to the words it finds in the document. It is able to analyse rules according to a rules definition language which provides a user defining a rule with a facility to match words exactly, with case sensitivity, according to similarity, according to a phonetic match, a semantic match and a stemmed match. Also, the rules language allows rules to be established which test for the distance between words, the position of the word in the document, for example by means of paragraph number, sentence number or location (title, authorship or heading).

The result of classification according to the rules is a list of categories and scores for the document. The rules engine 122 manages different categories of scores for a document, and returns a list of categories and scores for that document once the review of the document has been completed. Scores can be calculated (depending on the manner in which rules are programmed by a user) on the basis of different scoring methods.

For example, accumulative scoring allows a score to be added each time a condition is met in a document, a one off scoring basis allows a score to be added to a category only once for a particular document (so that later instances of a particular condition being met have no impact on the score), or on a weighted basis. A weighted basis is exemplified by an exponential decay, whereby a score is added to a total score for a document on each occasion that a condition is met, with the additional score becoming repeatedly smaller on each additional occasion that the condition is met. Positive and negative weightings can be provided.

As illustrated in FIG. 10, the rules engine 122 includes a rules manager 130 which is operable to receive a string of text containing a rule definition in rule definition language from the database 36 or directly entered by a user at the agent administration interface 126. In practice, the string of text will arise when an agent defined in the agents definition unit 120 is invoked by a user to perform a categorisation of a document obtained in a search.

The rules manager 130 comprises a rules parser 132 which is operable to construct rule data structures from the text input by a user to define the rules. The rules parser 132 identifies combinations of words and symbols in the input text and forwards them to a look up table constructor 134 which forms one or more program statements therefrom, and references to the program statements 136 in a words-to-rules look up tables unit 138. The words-to-rules look up table unit 138 is used, in document classification, to relate words identified in the document with program statements so as to generate class scores which are stored in a class scores storage unit 140.

FIG. 14 illustrates operation of the agent administrator 34, in the conducting of searches and analysis of search results. For each agent initialised in the agent administrator 34, the word or words used to define things in the agent are sent to the scheduler 50 in step S1-2, for searches to be initialised. A check is then made in step S1-4 as to whether search results have been received. When search results are received, in step S1-6, a document found in the search is considered by the agent. Then, in step Si-8, the number of occurrences of the theme word in question in document being considered is counted. In step S1-10, the number of occurrences is multiplied by the weighting factor for the word in question. The product to this multiplication is stored, in step S1-12, as a relevance value for the document, in relation to the theme defined by the theme word.

Then, in step S1-14, an enquiry is made as to whether the agent, comprising the theme in question, also comprises any rules. If so, then in step S1-16, the rule is considered for analysis of the document. Then, the rule is parsed in step Si-18, making use of the rules parser 132.

Operation of the rules parser 132 is by means of a method as illustrated in FIG. 17. The rules parser, in step S4-2, receives a string of characters, originally input by a user, and stored in the database 36, for analysis. The rules parser analysis the string of characters until a token (a recognised string of characters used in the language the basis of the parser) is found. If an enquiry is made in step S4-4 as to whether a token has been found by the rules parser 132. If a token is found, then the token is parsed in step S4-6. Then, or if no token is found in step S4-4, an enquiry is made, in step S4-8, as to whether the end of the input character string has been reached. If not, then processing of the character string continues from step S4-4 onwards. Once the end of the string is found in step S4-8, the parsing procedure ends. The consequence of processing the parsing procedure is that parsing of a character string defining a rule is carried out.

Parsing involves translating the characters into their representative token and analysing the sequence of tokens in a character string so that the meaning assigned to that character string, given the conventions of the rule definition language, can be developed into rule data structures. These rule data structures consist of entries in the words-to-rules look up tables unit 138, developing a relationship between words used in rule definitions and the rules defined by the input character string, and program statements 136, which define processing steps to be carried out on recognition of means of input text as corresponding to the arguments of a rule to be processed by a classification unit 150 of the rules engine 122.

After rules have been constructed in this way, document classification takes place using the classification unit 150 of the rules engine 122. In step S1-12, the classification unit 150 applies the rule to the document. The classification unit includes a HTML classifier 152 which incorporates a lexical analyser to scan an input stream of text presented to it in HTML and passes separate words and tags to a word classifier 154.

The word classifier 154 accepts words from the HTML classifier 152 and passes them to the words to rules look up tables unit 138. The words-to-rules look up tables unit refers to its look up tables to establish which of the rules defined in the programs statements 136 have the word in question (whether exactly, semantically, phonetically or otherwise matched) as an argument. These program statements 136 are then applied and resultant class scores for the document in question stored in the class scores storage unit 140 in step S1-22.

In step S1-24, an enquiry is then made as to whether any more rules are associated with the agent in question, for consideration. If so, then the next rule is considered in step S1-16, and so on. Otherwise, or if the agent does not comprise any rules, an enquiry is made in step S1-26 as to whether the agent comprises any attributes. In the present example, the attributes table 174 contains one attribute, which is a “Block” attribute. In the present example, a “Block” attribute is one which searches for the argument of the attribute, in this case the URL “www.orange.com”, and rejects the document if it contains that argument.

That attribute is processed in step S1-28, in relation to the document in question. Thus, if, in the present example, the document contained a reference to the URL “www.orange.com” the document would be rejected. In step S1-30, an enquiry is made as to whether any more attributes remain to be processed. If so, then those attributes are processed in turn in step S1-28. Otherwise, or if, in step S1-26, the agent is found not to comprise any attributes, an enquiry is made in step S1-32 as to whether any more documents remain to be considered, in the search results returned from the searching subsystem 30. If so, then these documents are considered in turn from step S1-6 onwards. Once all documents have been considered, and their relevance and class scores have been obtained and stored, the procedure ends and the results are returned to the user interface 48.

The words to rules look up tables unit 138 is described in further detail in FIG. 11. The unit 138 includes an exact match table 160 which matches words to rules defined by a user. This table will be used by most rules defined and input into the rules manager 130. A stemmed match look up table 162 allows a user to specify that an argument of a rule can be stemmed. This is indicated in the rules language by log qualifying the argument with a stemming function. The stemmed match up look up table 162 matches all truncated forms of the argument in question and looks to match input words with those truncated forms. This ensures that inflections to a word such as pluralisations, tenses and the like are taken into account.

A hash table 164 provides a facility for storage of words for fast word look up. Hashing is a technique which allows words to be encoded, using the encoding to determine the order of words stored in a hash table. Thus, if an entry of a word is to be found, the hash code can be applied to the word and that application of the code will provide the address of the word in the hash table. This allows for substantially instant look up of a word in the table.

A sounds match look up table 166 allows a user to specify that all phonetic equivalents of a particular word are taken into account. Further, a semantic match look up table 168 allows a user to specify that all words synonymous with a particular argument are to be taken into account. These synonyms are found by the semantic match look up table 168 by reference to a thesaurus 170.

An example of agents defined in the agents definition unit 120 is illustrated in FIG. 12. In the agents definition unit 120, a themes table 170, a rules table 172 and an attributes table 174 define themes, rules and attributes to be made available to an administrator defining an agent. A theme is based on a particular word to be given a particular weighting in a document. In the present example, two themes have been defined in the themes table 170. Firstly, a theme defined as being based on the word “Orange” has been given the weighting 100, and a sign of 1 (denoting a positive weighting). This means that if a document contains the word “Orange”, that theme will score that document with a weighting of 100 for every instance of the word “Orange”. Other weighting systems are possible, as set out above. Also, a second theme is defined, based on the word “Apfelsine”. That word is a German word meaning “Orange”, and a document including that word could be equally relevant. Therefore, it is given the same weight as the earlier mentioned theme.

The rules table 172 contains a logical statement based around the word “Orange”. For reasons of clarity, the exact detail of the rule is omitted from the table as illustrated, but is set out below:

if “Orange” near “telephone” reject Orange

This rule is formulated such that if a document contains the word “Orange”, near the word “telephone”, the document is to be rejected by the orange agent. This prevents documents from being considered which are concerned with the well known mobile telephony company “Orange”, which documents would not be concerned with the citrus fruits with which the agent is concerned.

A series of mapping tables, namely a theme mapping table 180, a rule mapping table 182 and an attribute mapping table 184 are provided, to map defined agents, listed in an agents table 190, to themes, rules and attributes respectively. In the theme mapping table 180, an agent with the identification number 1 is mapped to themes 2 and 3. Similarly, that agent is mapped to rule 64 and attribute 128. Agent 4 is mapped only to theme 3.

A classification table 186 contains a list of classifications which will be used to collate scores for documents. Classifications are referred to in rules and store values which are adjusted on the basis of decisions made in accordance with rules described in terms of the rules language.

Further features of the rules language will now be described. The rules language is defined by the function of the parser in its ability to recognise functional words or phrases in a string of text.

Firstly, the rules language allows for words in a document to be matched to produce classification scores.

For example, the rule

for “dog” classify Canine

states that every time the word “dog” is encountered, the score for the classification “Canine” is incremented. At the beginning of the document, the score for Canine is set to zero. Basic word matching is not case sensitive.

More rules can be added, such as

for “cat” classify Feline

for “dog” classify Animal

for “cat” classify Animal

Note that in this example, the same word can be matched more than once, and that the same class can be matched more than once. Statements can be combined in curly brackets, so that the above rules could be rewritten

for “cat”
{

classify Feline
classify Animal

}
for “dog”
{

classify Canine
classify Animal

}

These rules return scores for three classes: Feline, Canine and Animal.

In addition to exact word matching described above, one of a list of words can be matched using the “or” operator. For example

for “computer” or “software” or “program” classify Computers

would increment the score for Computers each time one of the words in the list was found. This is equivalent to

writing the three rules

for “computer” classify Computers

for “software” classify Computers

for “program” classify Computers

Combination of words can also be matched, by combining them with the “and” operator. For example

for “Bill” and “Gates” classify Microsoft

must find both the words “Bill” and “Gates” to call the classify statement. “and” and “or” can be used at the same time, so that

for “Bill” or “William” and “Gates”

matches either “Bill” or “William” and the word “Gates”. Note that, in this rules language, the “or” operator has higher precedence than the “and” operator, which is contrary to normal operator precedence.

A stemming algorithm can be applied which stems each word before it is looked up. The keyword “stemmed” is inserted before the word to indicate that any stem of the word can be matched

for stemmed “pony” or stemmed “horse”

matches any stemmed word including “ponies” and “horses”. A phonetic match can be made by inserting the “sound” keyword in front of the word. The rule:

for sound “Clinton” and sound “Lewinsky”

is likely to be able to match misspellings of the names “Clinton” and “Lewinsky”. A case sensitive match can be specified by the “name” keyword. In this case,

for name “Clinton”

only matches the word Clinton if an instance of the word in a document matches the word exactly, including taking account of upper case letters. Phrases can also be matched, so that

for name “Bill Clinton”

for stemmed “fish cake”

does a case sensitive match for the phrase “Bill Clinton” and a stemmed match for the phrase “fish cake”.

Words, links and images an also be matched. This counts the number of words, links and images in the document:

for word classify Word

for image classify Image

for link classify Link

for “Michael Douglas” and image

if near (1, 2) classify MichaelDouglasPicture

The last rules only matches if the phrase “Michael Douglas” occurs near an image.

The themes associated with an agent can be matched by specifying “themes” as the matching phrase, which will match any theme associated with the agent. A specific theme can be matched, by giving its theme identification number. This example matches any theme in the document

for themes classify this

This example matches both the first and second theme of the agent. If the theme does not exist, the rule is never matched.

for theme 1 and them 2 classify Both

The basic “classify” statement increments the class score by one. To adjust the class score by a different number, a weighting can be specified. This example adds 40 to the score for English each time the word “the” is encountered. This rule is formulated because the word “the” is highly associated with the English language, and so can be used to give a high level of assurance that the document is in English.

for “the” classify English weight 40

A negative weighting can be given, such as

for “le” {classify English weight −3 classify French weight 2}

An arbitrary expression can be used to specify the weighting, such as

for “hen” classify Poultry weight 2*x—square (4)

By convention, there is a class name called “this” which is a class score for the agent currently being prepared.

So the rule

for “Madonna” classify this

would add one to the “this” score. Rules can also be “accepting” or “rejecting”, which add large positive or negative numbers to the class score. The following rules reject the class Currency if the word “stirling” is found, but accept the word “sterling” is found.

for “stirling” reject Currency

for “sterling” accept Currency

A rule can also set the weight of a score. For example

for “jeans” classify Music set 0

for “jeans” classify Clothing set 20

A classification can be adjusted just once, so that

for “the” classify English weight 15 once

would increase the score for English by 15 only once. The maximum number of times a rule is invoked is specified

for “the” classify English weight 10 max 4

which limits the contribution of this rule to 40 points. The contribution each weight makes to the score can be made to decrease exponentially. The following example adds a maximum of 80 points to the class “Computers.”

for “program” classify Computer weight 80 exp

The first time the word “program” is reached, 40 is added to the Computer class score. The scores 20, 10, 5, 2, 1, . . . are added as subsequent matches are found.

The rules language also allows for conditions to be included in rules. Conditions allow classification statements to be executed conditionally. Conditions can appear inside or outside “for” statements. A condition appearing inside a “for” statement can test for the relative positions and locations of the matched words. For example

for “Bill” and “Gates” if near (1, 2) classify Microsoft

classifies Microsoft if the first word is near the second word. An “else” clause can be given, so that for “Bill” and “Gates”

if near (1, 2) {accept Microsoft classify Legal} else classify Microsoft weight 3

“If” statements can be nested. Other textual conditions can be tested, and are listed in an appendix hereto. For example, the word position, sentence number, paragraph number, section number, and distances can be evaluated. The location can be tested to see whether it appears in a meta-tag, a link, a heading, or the title or if it is in bold, italic or is underlined.

A condition appearing outside a “for” statement can test general conditions about the document and query the class scores.

for “der” or “das” classify German

if German

{

for “Berlin” or “Heidelberg” classify GermanTourist

}
else
{

for “the” or “it” classify English
for “le” or “la” classify French

}

A score for a class is only updated after the classify statement that set it. Therefore a condition that tests the value of a class must occur in the text after classify statements that update the score.

A condition is taken to be true if it evaluates to a positive number. If the value is zero or negative, the condition is false.

Many functions such as “near”, “distance”, “position”, “sentence”, and “paragraph” accept word numbers as their arguments. Every “for” statement must match a list of phrases, and the word number is its position in the “for” statement. The following rule is matched if the first phrase (“Uma Thurman”) is near the second phrase (“Nike Trainers”)

for name “Uma Thurman” and “Nike Trainers”

if near (1, 2) // . . .

The following rule is matched if either “Bill Gates” or “William Gates” (the first phrase) occurs in the same sentence as “richest” or “wealthiest” (the second phrase).

for “Bill Gates” or “William Gates” and stemmed “richest” or stemmed “wealthiest” if sentence (1)=sentence (2) // . . .

The following example must match 3 different phrases, and tests to make sure that they all appear in the same section of a document.

for “Bill Gates” and

“Judge Jackson” or “Jackson” and

“breakup” or “split”

if section (1)—sentence (2)—section (3) // . . .

Every expression in the described rule language has a fixed point floating point type. Booleans are represented as true=1.0 and false=0.0. Each string is translated to an integer index, which is similar to a pointer as used in C.

Function calls have the general form

function_name (arg1, arg2, . . . )

where “function_name” is the name of a built in function, and arg1, arg2 . . . are themselves expressions. The statement

print(“Invalid input\n”)

calls the “print” function to output the given string. Note that escape characters may be used in the string. Each function must receive the correct number of arguments, or a compile-time error occurs. Each function also has a numerical return value, so in this example the links ( ) function returns the number of links in the page

if links ( )>20 accepts linkspage

The name of a class evaluates to its score, so that the expression

German>30

evaluates to true if the class score for German is greater than 30.

It should be noted that expressions can be evaluated in two different circumstances. The first circumstance is when a word has been matched, so is before the entire document has been processed. These expressions occur within a “for” statement. In this case, the class scores are all zero, and some functions such as links ( ) and images ( ) return incomplete results. Expressions that are executed outside “for” statements are executed after the whole document has been processed, and the class values can be used.

The comparison operators=(equal to), !=(not equal to), <(greater than), >=(less than), >=(greater than or equal to) and <=(less than or equal to), return the Boolean value 0 or 1 depending upon the comparative values of their operands. “Not”, “and” and “or” are fuzzy Boolean operators, described in the next section.

The standard arithmetic operators in the language are available, including+(addition), −(subtraction), * (multiplication), /(division) and % (modulo). Normal operator precedence applies, and round brackets can be used to group expressions.

All truth values in the rule language are fuzzy, and are represented as continuous belief values within the range 0 to 1 inclusive. For example a degree of belief of 0.2 represents a relatively unlikely circumstance, while 0.99 represents a highly likely circumstance. In fuzzy logic,

not x evaluates 1-X

x and y evaluates to the minimum of X and Y

x or Y evaluates to the maximum of X and Y

The statements

P(Burglary)=0.001

P(Earthquake)=0.002

assign the values 0.001 and 0.002 to Burglary and Earthquake respectively, and is equivalent to

Burglary=0.001

Earthquake=0.002

Conditional probabilities are expressed as

P(Alarm|Burglary and Earthquake)=0.95

P(Alarm|Burglary and not Earthquake)=0.95

P(Alarm|not Burglary and Earthquake)=0.95

P(Alarm|not Burglary and not Earthquake)=0.95

P(JohnCalls|Alarm)=0.95

P(JohnCalls|Not Alarm)=0.05

P(MaryCalls|Alarm)=0.70

P(MaryCalls|not Alarm)=0.01

The probabilities form a belief network that can propagate values forwards through the network. The above example calculated probabilities (or belief values) for Alarm, JohnCalls and MaryCalls given the initial conditions Burglary and Earthquake. Changing the initial conditions (for example as a result of document analysis) propagates different belief values through the network.

The result is a set of probabilities (or belief values) for various properties about the document.

Further features of the rules language are now set out below.

Comments

Comments are written in C++ style, for example

for “cat” and “mouse” // Matches cartoon characters

In this example, the comment is “Matches cartoon characters”. The text of the comment is purely for guidance of the human operator and this text is disregarded by the parser.

Compound Statements

A statement may be composed of a list of other statements, in curly brackets. For example

for “der” or “das” and “kapital”

{

classify German
if near (1, 2) accept Book

}

While Loops

While loops are executed while the condition is true. The following example sums the first 10 integers.

x=10

y=0

while X>0

{

y = y + x
x = X − 1

}

Function Calls

A function call can also be used as a statement, for example

if links ( )>100

print (“This looks a bit like a links page.\n”)

Assignment Statements

An alternative notation for

classify x set x+1

is

x=x+1

The following example computes the factorial of 10.

x=10

Factorial=1

while x>0

{

Factorial = Factorial * x
x = x − 1

}

Return Statements

A class can be tagged as “returned” meaning that the class value should be treated as a return value. This does not affect the running of the rules. The following example tags “English”, “French” and “German” as valid return classes—other classes are ignored.

return English

return French

return German

The monitoring subsystem 32 will now be described. The monitoring subsystem comprises a data retriever 200 which contains a data source manager 202. The data source manager controls the identity of sources to be analysed by the data retrieval scheduler 204. Sources may include newsgroups and chatrooms, each of which is identifiable by an address. A newsgroup is a facility which allows a user to post a short textual document to a central server location for retrieval by an subscriber. A chatroom is a facility which allows a user to send small messages for immediate retrieval by another party, for real time response.

Thus, newsgroups and chatrooms are slightly different, in that a newsgroup is slightly less dynamic than a chatroom. The data retrieval scheduler 204 is operative to instance retrieval processes 206 on the basis of criteria set by the data source manager 202. The data retrieval scheduler 204 would instance retrieval processes 206 for a chatroom to be monitored constantly, and newsgroups to be monitored periodically, for instance daily. Each retrieval process 206 comprises a document retrieval unit 208, which is operable to retrieve documentary information from the identified source. A duplicate checker 210 identifies whether the retrieved document or documents have previously been retrieved on previous monitoring processes to the document source.

New documents retrieved by the retrieval processes 206 are stored in the database 36. From there, a data analyser 212 analyses the document to establish whether it is of any relevance to the themes, rules and attributes collectively assembled as agents in the agent administrator 34. The data analyser 212 comprises a classifier 214 which passes documents to the agent administrator 34 for checking against defined agents. Results of analyses carried out by the agents, are passed to a results collator 216. Further, a links extractor 218 extracts hypertext links to other URLs in the documents under analysis. These links can then be passed to the searching subsystem 30 for further analysis and instancing of link validation processes 54 on that basis.

Finally, a user interface 220 allows configuration of the monitoring subsystem 32, to identify data sources in the data source manager 202 and to manage the scheduling of data retrieval in the data retrieval scheduler 204. The user interface 200 also provides a facility for display of results, collated in the results collator 216.

In use of the system, searches are initialised in the searching subsystem 30 by reference to agents defined in the agents definition unit 120. A user can use an existing agent defined in the agents definition unit or can use the user interface 48 to define further agents. Each agent will contain one or more themes, and optionally one or more rules and attributes. The themes are used to seed searches at search engines, which cause a plurality of search results to be returned to the searching subsystem 30. These results are defined further, having regard to the rules and attributes, until a set of refined results, ranked in a preferred order, such as alphabetically or in order of relevance, can be presented to the user.

Whereas the crawler 44 has been described as extracting links for further analysis, it could be provided that links are extracted on the basis of analysis with respect to themes and rules associated with an agent on the basis of which the crawler is operating. In that way, the number of links extracted can be maintained at a manageable level.

In that way, searches can be carried out which do not result in an impractically large number of results, which would be of no use to a commercial organisation.

The use of the monitoring subsystem 32 is slightly different from the use of the searching subsystem 30, in that the agents do not initiate searching in the monitoring subsystem 32. In that case, documents are retrieved in a periodic manner from data sources, and are passed to the agents to establish if any of the documents are of interest. The exact locations from which documents are retrieved could be the result of searching carried out by the searching subsystem 30.

Whereas the invention has been described with reference to websites available via the Internet and with reference to newsgroups using NNTP, other sources of data could be used with the present invention. For example, databases available remotely could be interrogated periodically on the basis of search terms seeded by an agent as described herein. This could be of use with patents databases and publications databases of any nature. The results of those searches could be analysed, in the same way. In particular, each entry in a publications database normally includes an abstract of the publication, which could be passed to the agents for a relevance classification.

The search and monitoring system can be embodied by a plurality of computers, operable in parallel with separate processing power, and the search scheduler 50, the link validation scheduler 54 and the crawl scheduler 58 can be operable to allocate processes 52, 56, 60 respectively to be executed on different computers to manage processing resources effectively.

Whereas FIG. 1 illustrates a system whereby information is hosted on HTTP information hosting units 14 and NNTP information is hosted on an NNTP information hosting unit 15, it will be appreciated that information stored for retrieval in both protocols can be hosted on a single machine.

Whereas the present invention has been exemplified by a system for retrieval of information, whether from “static” information sources such as websites or dynamic information sources such as newsgroups, it will be appreciated that the invention can also be applied to system for retrieving information, processing that information and acting on the results of the processing. For example, a system could be configured to retrieve stock market prices and other business information from particular sources and to perform calculations on the basis of that information to cause business transactions to be performed. These decisions can be configured in the rules language described herein, possibly with further decision making extensions to that language.

Further, a system in accordance with the invention could be configured to refer to websites offering shopping services, to compare prices and to give the user information concerning those prices so that the user can obtain the optimum price for goods or services which he may require.

Whereas the invention has been described in relation to specific example of searching websites and monitoring newsgroups, it will be appreciated that any published source of information accessible via a computer network can be used in connection with the invention. For example, the system could be configured to monitor websites with rapidly changing content, such as those operated by newspapers or news gathering organisations, web bulletin boards which are similar to newsgroups but allow the posting of messages on a website handled in HTTP, and chatrooms which provide a scrolling message recordal facility so that users can conduct conversations with other users.

The invention can also be applied to new protocols such as “hotline”, Napster (for the exchange of audio information) and ICQ (a messaging service).

Whereas the administrator interface 46 is illustrated in FIG. 4 in schematic form, each element thereof, namely the item adding unit 70, the item removal unit 72, the item viewer/editor 74 and the search results viewer 76 can be embodied as a Windows (Trade Mark, Microsoft) based graphical user interface. For instance, each of the functional elements can be placed on a separate tab of a windowing graphical user interface.

It will be appreciated that, where the search scheduler 50 is specified to schedule searches to be issued no more frequently than five seconds apart, the frequency of the schedule is capable of being altered to suit prevailing conditions. It may be the case that the administrator of a search engine may raise a complaint against the operator of the system of the illustrated example that search requests are being delivered thereto at too frequent a rate, in which case the search requests can be issued at a less frequent rate. Alternatively, the time period between search requests can be shortened in the event that it is perceived that searching is taking an unduly long time to be completed.

Whereas the system has been described in terms of a computer network including a plurality of, for instance, PC based computers, it will be appreciated that some elements of the user interface could be incorporated in an embedded system for implementation on a mobile communications device, such as a mobile telephone. In that way, a user would be able to make a query of a system in accordance with the present invention and to obtain collated results therefrom, or to obtain a simplified version of collated results therefrom. Such a system could take account of a limited communications speed between the mobile device and other devices, and limits the amount of data to be transferred accordingly.

Whereas the illustrated example is shown to demonstrate use of the present invention in discriminating and classifying words of the English language using word frequencies, it will be appreciated that similar techniques could be used to recognise other languages. In the case of agglomerative languages where words are frequently combined to produce longer, compound words, stemming may form a significant part of the language recognition process. Also, letter frequency, including analysis of the position of letters in words, could be used to recognise certain languages.

Certain languages are known to make little or no use of particular letters, for example the letter “j” is very rarely used in Italian. Also, in the Italian language, many words end in a vowel. Each of these facts could be used to classify a document as being written in the Italian language.

Also, whereas the rules definition language described herein is expressed using words derived from English language words, it will be appreciated that other natural languages could be used as basis for the logical statements. Also, a more symbolic or graphical rule definition language could be used.

### Appendix—Rule Language Description

Functions Reference

after(word1, word2)

Returns a true value if the first word appears after the second word in the document.

before(word1, word2)

Returns a true value if the first word appears before the second word in the document.

distance(word1, word2)

A value representing the number of words separating the two words identified as arguments of the distance function. Returns how far apart the two words are.

images( )

Returns the number of images found in the document.

in_author(word)

Returns true if the word appears in the author identification section of the document.

in_bold(word)

Returns true if the word is in bold.

in_description(word)

Returns true if the word appears in the description of the document.

in_heading(word)

Returns true if the word appears in a heading.

in_heading1(word)

Returns true if the word appears in a heading style 1.

in_heading2(word)

Returns true if the word appears in a heading style 2.

in_heading3(word)

Returns true if the word appears in a heading style 3.

in_italic(word)

Returns true if the word is in italic.

in_keywords(word)

Returns true if the word appears in the keywords of the document.

in_link(word)

Returns true if the word appears in a link.

in_meta(word)

Returns true if the word appears in any meta-tag of the document.

in_title(word)

Returns true if the word appears in the title of the document.

in_underline(word)

Returns true if the word is in underline.

in_url(word)

Returns true if the word appears in the URL of the page.

links( )

Returns the number of links found in the document.

near(word1, word2)

Returns true if the distance between the words is less than 20.

num_themes( )

Returns the number of themes associated with the agent.

paragraph(word)

Returns the paragraph number of the word.

position(word)

Returns the word number of the word in the document.

print(string)

Outputs the string to the terminal.

printn(x)

Outputs the number x to the terminal.

section(word)

Returns the section number of the word.

sentence (word)

Returns the sentence number of the word.

sentence₁₃ position (word)

Returns the position of the word within a sentence.

sequence(word1, word2)

Returns true if the first word is immediately followed by the second word.

square(x)

Returns x*x.

words( )

Returns the number of words in the document.

word_length( )

Returns the average length of the words in the document.

1. Computer apparatus for discriminating items of information comprising:
a search term store operable to store a search term for configuring a search engine to identify items of information for discrimination;
an information retriever operable to retrieve items of information identified by said search engine with respect to a search term stored in said search term store;
a discrimination criterion store operable to store data defining a discrimination criterion to be applied to an item of information; and
an information discriminator operable to apply discrimination criterion stored in said discrimination criterion store to an item of information, to generate one or more classification scores for said item of information.

2. Information discrimination apparatus operable to receive and analyse items of information, comprising:
an information receiver operable to receive an item of information for analysis;
one or more information analysis agents, the or each agent comprising at least one theme being an item of textual information to be compared to said item of information for analysis, and one or more rules, the or each rule being a logical statement to be applied to said item of information for analysis; and
an analyser operable to compare for the or each of said information analysis agents, said at least one theme with an item of information received by said information receiver to thereby generate a relevance score, and to apply said rule or rules to an item of information to thereby obtain one or more classification scores.

3. Apparatus according to claim 2 further comprising an instruction dispatcher operable to send instructions to a search engine at a remote location for items of information relating to a theme of one of said one or more information analysis agents, said information receiver being operable to receive items of information on the basis of results of a search performed by said search engine.

4. Apparatus according to claim 3 wherein said instruction dispatcher comprises: a search engine request scheduler operable to manage configuration of one or more search engines to search in respect of themes.

5. Apparatus according to claim 3 wherein said information receiver is operable to receive results information from a search engine, said results information comprising one or more identifiers of locations of items of information identified by said search engine as relevant to said search criterion, said information receiver comprising an identified item retriever operable to retrieve the or each item of information from its location identified by said one or more identifiers.

6. Apparatus according to claim 5 further comprising an additional item identifier detector operable to detect if an identified item comprises an identifier to a location of an item of information, and operable to configure said identified item retriever to retrieve from any detected identifier the corresponding item of information.

7. Apparatus according to claim 5 further comprising an identified item store for storing items of information retrieved by said identified item retriever means.

8. Apparatus according to claim 7 wherein said identified item retriever is operable to compare a retrieved identified item with information stored by said identified item store, said identified item store being operable to store said identified item on condition said identified item is not already stored by said identified item store, items stored by said identified item store in use having said analyser applied thereto.

9. Apparatus according to claim 2 wherein said information receiver comprises a retrieval schedule store operable to store a schedule for retrieval of items of information from identified remote locations, said information retriever being operable to retrieve items of information in accordance with a retrieval schedule stored said retrieval schedule store for analysis by said analyser.

10. Apparatus according to claim 2 wherein said analyser comprises a text data extractor operable to extract text data from a retrieved item of information, and wherein said analyser is operable to apply a text classification rule in one of said information analysis agents to text data extracted by said text extractor means.

11. Apparatus according to claim 10 wherein said analyser comprises an image data extractor operable to extract image data from a retrieved item of information, and wherein said analyser is operable to apply an image classification rule in one of said information analysis agents to image data extracted by said image extractor.

12. Apparatus according to claim 10 wherein said analyser comprises an audio data extractor for extracting audio data from a retrieved item of information, and wherein said analyser is operable to apply an audio classification rule in one of said information analysis agents to audio data extracted by said audio extractor.

13. Apparatus according to claim 10 wherein said analyser comprises video data extractor means for extracting video data from a retrieved item of information, and wherein said analyser is operable to apply a video classification rule in one of said information analysis agents to video data extracted by said video extractor.

14. Apparatus according to claim 10 wherein said analyser is operable to apply a plurality of classification rules to a retrieved item of information and wherein said analyser comprises a classification information collator operable to collate results of the application of said rules to said item of information.

15. Apparatus according to claim 14 wherein said analyser is operable to generate a numerical result in respect of application of a rule to an item of information, said collator being operable to collate numerical results into one or more cumulative totals.

16. Apparatus according to claim 10 wherein the or each information analysis agent stores the or each rule as a text storing, and said analyser comprises a parser operable to parse said text storing to define a classification rule.

17. Apparatus according to claim 16 wherein said parser is operable to identify a token in said data, said token being a keyword of a rule.

18. Apparatus according to claim 17 wherein said parser is operable to identify one or more tokens as arguments of an identified keyword token.

19. Apparatus according to claim 18 wherein said parser is operable to define a classification rule to which data from a retrieved item of information can be applied.

20. Information discrimination apparatus operable to receive and analyse items of information, comprising:
an information receiver operable to receive an item of information for analysis;
an information analysis agent store, for storing an information analysis agent, said store being operable to store, for an agent, a theme comprising an item of textual information for comparison with an item of information for analysis, and a rule comprising a logical statement to be applied to an item of information for analysis; and
an analyser for comparing a theme stored in said store means with an item of information for analysis, and for applying a rule to said item of information, thereby to generate a relevance score with respect to said theme and a class score with respect to said rule for said item of information.

21. A method of discriminating items of information comprising:
storing a search term for configuring a search engine to identify items of information for discrimination;
retrieving items of information identified by said search engine with respect to said search term;
storing data defining a discrimination criterion to be applied to an item of information; and
applying said discrimination criterion to an item of information, to generate one or more classification scores for said item of information.

22. A method of analysing items of information comprising, on receipt of an item of information for analysis, the steps of:
comparing said item with an item of textual information defining a theme and from said comparison establishing a relevance score; and
applying to said item of information a logical statement being a rule resulting in generation of one or more classification scores for said information.

23. A method according to claim 22 comprising:
sending an instruction to an information source at a remote location for items of information relating to a theme and receiving an item of information on the basis of the results of a search performed by said search engine.

24. Method according to claim 23 wherein said method comprises storing a search criterion, and configuring a search engine at a remote location to search on the basis of a search criterion stored in said search criterion storing step.

25. Method according to claim 24 wherein said search engine configuring step comprises managing configuration of one or more search engines to search in respect of stored search criteria.

26. Method according to claim 24 wherein said receiving step comprises receiving results information from a search engine, said results information comprising one or more identifiers to locations of items of information identified by said search engine as relevant to said search criterion, and retrieving the or each item of information from its location identified by said identifier.

27. Method according to claim 26 further comprising detecting if an identified item comprises an identifier to a location of an item of information, and retrieving, in accordance with any detected identifier, the corresponding item of information.

28. Method according to claim 26 further comprising storing a retrieved item of information.

29. Method according to claim 28 comprising comparing a retrieved identified item with information stored in said storing step, and storing said identified item on condition said identified item is not already stored, and applying to items stored in said preceding step said stored discrimination data.

30. Method according to claim 22 wherein rule applying step comprises extracting text data from a retrieved item of information, and applying a text classification rule to text data extracted in said text data extracting step.

31. Method according to claims 22 wherein said rule applying step comprises extracting image data from a retrieved item of information, and applying an image classification rule to image data extracted in said image data extracting step.

32. Method according to any of claim 22 wherein said rule applying step comprises extracting audio data from a retrieved item of information, and applying an audio classification rule to audio data extracted by said audio data extracting step.

33. Method according to claim 22 wherein said rule applying step comprises extracting video data from a retrieved item of information, and applying a video classification rule to video data extracted by said video data extracting step.

34. Method according to claim 30 wherein said rule applying step comprises applying a plurality of classification rules to a retrieved item of information and collating the results of the application of said rules to said item of information.

35. Method according to claim 34 wherein said rule applying step comprises generating a numerical result in respect of application of a rule to an item of information, said collating step comprising collating numerical results into one or more cumulative totals.

36. A method according to claim 30 wherein said rule applying step comprises parsing data stored to define said rule into a logical statement to define a classification rule.

37. A method according to claim 36 wherein said parsing step comprises identifying a token in said data as a keyword of a rule.

38. A method according to claim 37 wherein said parsing step comprises identifying one or more arguments of an identified keyword token.

39. A method according to claim 38 wherein said parsing step comprises defining a classification rule on the basis of an identified keyword and one or more identified arguments, to which data from a retrieved item of information can be applied.

40. A computer program product comprising processor executable instructions operable to configure a computer to become operable as apparatus in accordance with any of claims 1 to 20.

41. A computer program product comprising processor executable instructions operable to configure a computer to perform a method in accordance with any of claims 21 to 39.

42. A system comprising a computer apparatus in accordance with any of claims 1 to 23 and a user terminal, said user terminal comprising:
a user instruction receiver operable to receive a user instruction for initiating operation of said computer apparatus for retrieving and discriminating items of information;
a discrimination information receiver operable to receive, from said retrieving and discriminating apparatus, discrimination information identifying items of information including one or more themes and one or more rules; and
an information output unit operable to output said information to a user.

43. A user terminal for use in a system according to claim 42, comprising:
a user instruction receiver operable to receive a user instruction for initiating operation of said computer apparatus for retrieving and discriminating items of information;
a discrimination information receiver operable to receive, from said retrieving and discriminating apparatus, discrimination information identifying items of information; and
an information output unit operable to output said information to a user.

44. A computer program product comprising processor executable instructions operable to configure a computer as a user terminal in accordance with claim 43.
